(19) United States
(12) Patent Application Publication
(10) Pub. No.: US 2025/0232244 A1
(43) Pub. Date: Jul. 17, 2025

(54) PROCEDURE ANALYSIS USING MULTIPLE CATEGORY-SPECIFIC MODELS

(71) Applicant: Wells Fargo Bank, N.A., San Francisco, CA (US)

(72) Inventors: James Hubbard, Charlotte, NC (US); Manesh Saini, New York, NY (US); Carleton Jay Lindgren, Jr., Denver, CO (US)

(21) Appl. No.: 18/412,056

(22) Filed: Jan. 12, 2024

(51) Int. Cl. G06Q 10/0639; G06Q 10/10

(52) U.S. Cl. CPC G06Q 10/06393; G06Q 10/10

(57) ABSTRACT

A computing system may generate, using a plurality of category-specific models, a plurality of validation reports assessing a procedure associated with an organization, wherein each category-specific model of the plurality of category-specific models is associated with a corresponding business function of the organization and is trained via machine learning to produce a corresponding validation report that is a written assessment of whether the procedure is satisfactory for the corresponding business function. The computing system may generate, based on the plurality of validation reports, a combined validation report that is a written assessment of whether the procedure is satisfactory for the organization.

### TECHNICAL FIELD

This disclosure relates to computing systems, and more specifically, to techniques for analyzing written procedures using machine learning.

### BACKGROUND

In recent years, organizations such as businesses have increasingly integrated machine learning into their operations. Organizations have recognized the potential of machine learning to drive innovation, efficiency, and competitiveness, and are using machine learning algorithms to analyze vast datasets, uncovering insights and patterns that inform decision-making for those organizations. Recently, organizations have begun to use large language models for purposes of data analysis to summarize large volumes of text and to extract actionable insights.

### SUMMARY

This disclosure describes techniques for using machine learning to analyze procedures within an organization. A computing system of the organization may train multiple category-specific models using machine learning to analyze procedures within an organization and to provide category-specific validation for different aspects of an organization's operations.

Each category-specific model may correspond to a specific business function of the organization and may be a large language model that is trained to analyze and provide assessment of procedures for the organization with respect to compliance with requirements or expectations of the corresponding business function. The computing system may use multiple category-specific models that correspond to different business functions of the organization to analyze a procedure to produce multiple different assessments of the procedure from the point of view of multiple different business functions of the organization. The computing system may combine the multiple different assessments of the procedure to determine an overall assessment of the procedure to determine whether the procedure should be implemented in the organization.

By training multiple category-specific models that each assess procedures from the point of view of a corresponding business function, the techniques described in this disclosure may enable such category-specific models to be more quickly and easily trained to produce more accurate assessments of procedures compared to training a single procedure assessment model that considers all of the different business functions of an organization to produce accurate assessments of procedures. Further, the parameter size of a category-specific model may be much smaller than that of an omnibus model, which may decrease the memory usage of category-specific models and may increase the inference speeds of the category-specific models.

In some aspects, the techniques described herein relate to a method including: generating, by one or more processor and using a plurality of category-specific models, a plurality of validation reports assessing a procedure associated with an organization, wherein each category-specific model of the plurality of category-specific models is associated with a corresponding business function of the organization and is trained via machine learning to produce a corresponding validation report of that is a written assessment of whether the procedure is satisfactory for the corresponding business function; and generating, by the one or more processors and based on the plurality of validation reports, a combined validation report that is a written assessment of whether the procedure is satisfactory for the organization.

In some aspects, the techniques described herein relate to a computing system including: memory configured to store a plurality of category-specific models; and one or more processors configured to: generate, using the plurality of category-specific models, a plurality of validation reports assessing a procedure associated with an organization, wherein each category-specific model of the plurality of category-specific models is associated with a corresponding business function of the organization and is trained via machine learning to produce a corresponding validation report that is a written assessment of whether the procedure is satisfactory for the corresponding business function; and generate, based on the plurality of validation reports, a combined validation report that is a written assessment of whether the procedure is satisfactory for the organization.

In some aspects, the techniques described herein relate to a non-transitory computer-readable medium including instructions that, when executed, cause one or more processors of a computing system to: generate, using a plurality of category-specific models, a plurality of validation reports assessing a procedure associated with an organization, wherein each category-specific model of the plurality of category-specific models is associated with a corresponding business function of the organization and is trained via machine learning to produce a corresponding validation report that is a written assessment of whether the procedure is satisfactory for the corresponding business function; and generate, based on the plurality of validation reports, a combined validation report that is a written assessment of whether the procedure is satisfactory for the organization.

The details of one or more examples of the disclosure are set forth in the accompanying drawings and the description herein. Other features, objects, and advantages of the disclosure will be apparent from the description and drawings, and from the claims.

### BRIEF DESCRIPTION OF THE DRAWINGS

FIG. 1 is a conceptual diagram illustrating an example system for procedure analysis using category-specific models, in accordance with one or more aspects of the present disclosure.

FIG. 2 is a block diagram illustrating an example computing system, in accordance with one or more aspects of the present disclosure.

FIG. 3 is a flow diagram illustrating operations performed by an example computing system, in accordance with one or more aspects of the present disclosure.

### DETAILED DESCRIPTION

In general, aspects of this disclosure are directed to using multiple category-specific models that are trained using machine learning to analyze procedures within an organization. At organizations such as a bank or other financial services organizations, it may be important for the organization to assess many different aspects of the organization's procedures. For example, it may be important for the organization to assess its procedures for compliance with laws and regulations, compliance with data security and privacy standards, compliance with ethical standards, financial integrity, process efficiency, possible reputational harm, and the like. When considering whether to adopt a new procedure, the organization may have to assess all of these different aspects of the new procedure. Furthermore, when laws or regulations affecting the organization changes, such as when a new law or regulation comes into effect, it may be important for the organization to assess its current procedures for compliance with the new law or regulation.

To assess a procedure, various different business functions of the organization may collaborate to assess the procedure to determine whether the procedure is satisfactory for the organization and to determine whether to recommend implementing the procedure in the organization. For example, the different business functions may collaborate to assess whether the procedure complies with applicable laws, regulations, and/or standards of the various business functions, potential risks of the procedure and/or the level of risk of the procedure, and the like.

Such collaboration may require multiple meetings, multiple e-mail exchanges, and the like, which may require months of work in order to produce a final assessment of the procedure. Such manual assessment of procedures may prevent the organization from being able to quickly adopt new procedures and may take time that could be used for other, more important, tasks away from business functions assessing the procedure. Further, human review of procedures by personnel working in the different business functions may lack consistency and objectivity, leading to potential errors and inefficiencies in the assessment process.

Instead of requiring manual review of procedures, an organization may use machine learning to assess procedures and to determine whether to implement the procedures in the organization. For example, an organization may train a procedure assessment model using machine learning to receive a procedure as input and to output an assessment of whether the procedure is satisfactory for the organization.

However, given that an organization may have many different business functions that may be affected by the procedure, it may be challenging to train a procedure assessment model that properly accounts for all of the different business functions of the organization and that produces accurate assessments. Training a single model to generate a validation report for the entire organization may produce a model that does not adequately consider the specific requirements and characteristics of different business functions. This lack of granularity can limit the accuracy and usefulness of the assessment reports, as they may not adequately address the specific needs and challenges of each and every business function.

In accordance with aspects of the present disclosure, instead of training a single model to assess whether to implement a procedure within an organization, a computing system may train category-specific models that are each specific to a particular business function of the organization to produce an assessment of whether a procedure should be implemented in the organization. Because each model is associated with a particular business function, each model may be tailored to the specific business function and may be able to accurately capture the unique requirements and nuances of the specific business function. Furthermore, each model may be easier to train in order to accurately produce assessments from the point of view of the specific business function, as each model may not have to be trained to account for multiple different business functions of the organization.

The techniques described in this disclosure provide several technical advantages. By training multiple category-specific models that each assess procedures from the point of view of a corresponding business function, the techniques described in this disclosure may enable such category-specific models to be more quickly and easily trained to produce more accurate assessments of procedures compared to training a single procedure assessment model that considers all of the different business functions of an organization to produce accurate assessments of procedures.

Further, because each category-specific model may only be trained to produce assessments of procedures for a specific business function, the parameters of a category-specific model may not include parameters of multiple different business functions. As such, the parameter size of a category-specific model may be much smaller than that of an omnibus model, such as the procedure assessment model described above, which may include parameters for all of the different business functions in the organization. By having a smaller parameter size, a category-specific model may take up less memory than an omnibus model and may have faster inference speeds compared to the omnibus model. This may allow multiple different category-specific models to execute in parallel, such as on different processors or different machines, to be able to more quickly produce assessments of procedures compared to a single procedure assessment model having a relatively much larger parameter size that considers all of the different business functions of an organization to produce assessments of procedures.

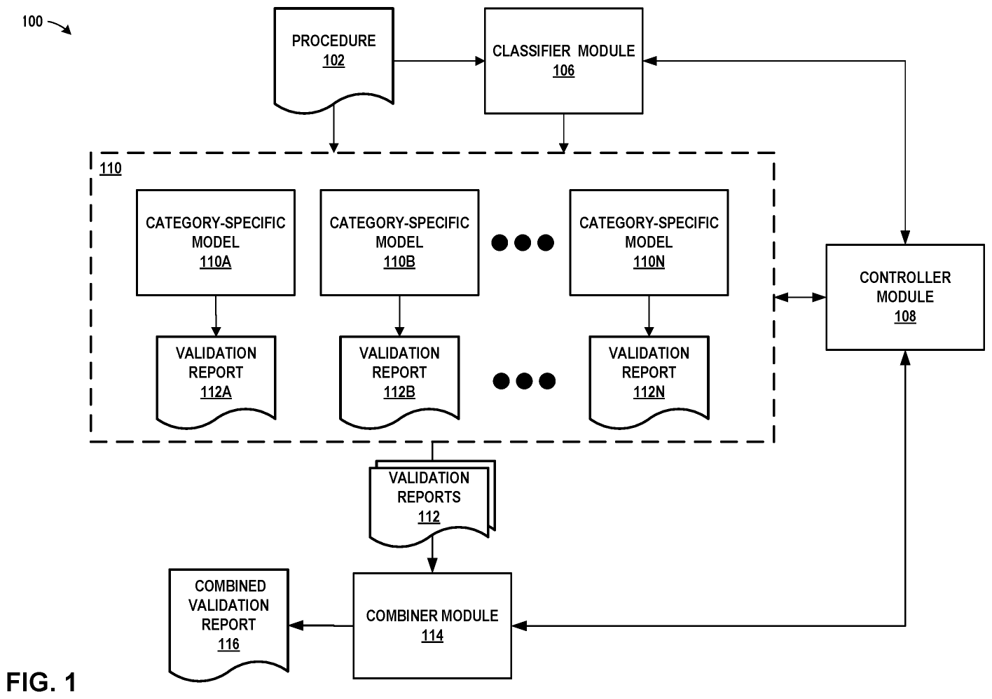

FIG. 1 is a conceptual diagram illustrating an example system for procedure analysis using category-specific models, in accordance with one or more aspects of the present disclosure. As shown in FIG. 1, computing system 100 may represent any suitable computing system including one or more computing devices, such as one or more desktop computers, laptop computers, mainframes, servers, and the like. In some examples, computing system 100 may represent a cloud computing system that provides access to its respective services via a cloud.

Computing system 100 includes classifier module 106, controller module 108, category-specific models 110A-110N (“category-specific models 110”), and combiner module 114. Classifier module 106, controller module 108, category-specific models 110, and combiner module 114 may be implemented as software that computing system 100 may execute, or may in some examples include any combination of hardware, firmware, and software.

Computing system 100 may be associated with an organization, such as a company, a financial institution, a school, a charitable organization, and the like. Computing system 100 may be operable to execute classifier module 106, controller module 108, category-specific models 110, and combiner module 114 to assess procedures, such as procedure 102, associated with the organization and to determine whether to implement the procedures in the organization. The procedures that computing system 100 is able to assess may include new procedures that are proposed for implementation within an organization, changes in or updates to procedures that are proposed for implementation within the organization, and/or current procedures that are assessed against new laws and/or regulations.

A procedure for an organization may be written documentation of a set of established methods or sequence of actions officially adopted by the organization to conduct its operations and activities. A procedure may set out step-by-step instructions designed to guide employees, customers, and/or other stakeholders in performing tasks or making decisions that align with the organization's policies, goals, regulatory requirements, and the like.

Procedures for an organization may encompass a wide range of activities, from routine daily tasks to complex decision-making processes. Procedures may ensure consistency and efficiency in operations, maintaining compliance with legal and regulatory standards, enhancing customer service, mitigating risk, and the like.

Examples of procedures in an organization may include policies and controls. An employee handbook may be an example of a procedure. In some other examples, a financial institution may have specific procedures for assessing a customer's creditworthiness for a loan, a procedure for repossessing a vehicle, a procedure for handling customer complaints, procedures for executing financial transactions, and the like.

Classifier module 106 is operable to receive a procedure 102 and to classify the procedure 102 into one of a plurality of tiers. Classifier module 106 may classify a procedure based on factors such as whether the procedure affects external customers of the organization, the number of external customers that are affected by the procedure, reputational risk to the organization, organizational impact of the procedure (e.g., the impact on human resources and/or regulatory compliance), and the like. For example, classifier module 106 may classify a procedure as being in the highest tier (e.g., tier 1) if classifier module 106 determines that the procedure affects external customers of the organization and may classify a procedure as being in a relatively lower tier (e.g. tier 2 or lower) if classifier module 106 determines that the procedure does not affect external customers of the organization.

In some examples, classifier module 106 may be trained using machine learning to receive a procedure as input and to output a classification of the procedure into a tier. In some examples, classifier module 106 may be implemented as an LLM, as an extreme Gradient Boosting (“XGBoost”) model, or by any other machine trained classification techniques.

Category-specific models 110 are trained using machine learning to assess and validate a procedure, such as procedure 102, and to generate validation reports 112A-112N (“validation reports 112”) that are written assessments of whether the procedure is satisfactory for the organization. Each category-specific model of category-specific models 110 may be associated with a corresponding business function of an organization. Examples of business functions of an organization may include legal, regulatory, human resources, process management, operational, information technology, marketing and sales, public relations, finance, and/or other business functions. For example, category-specific models 110 may include a category-specific legal model associated with the legal business function of the organization, a category-specific human resources model associated with the human resources business function of the organization, and the like.

Category-specific models 110 are each trained using machine learning to assess and validate a procedure, such as procedure 102, from the point of view of a corresponding business function. For example, a category-specific legal model may be trained to provide assessment of procedures from the point of view of the legal business function of the organization, such as to assess whether a procedure may cause any legal issues, such as issues relating to contractual issues, intellectual property issues, and the like, to arise for the organization. In another example, a category-specific regulatory model may be trained to provide assessment of procedures from the point of view of the regulatory business function of the organization, such as to assess whether a procedure complies with external laws, regulations, industry standards, and/or to assess and validate risk management issues regarding the procedure.

In some examples, each category-specific model may be a large language model (LLM) that is trained on corresponding category-specific data. Each category-specific model may be a foundational model that is further trained with data specific to the organization and/or to the business function of the organization. Examples of foundational models may include Generative Pre-trained Transformer (GPT), Claude, BigScience Large Open-science Open-access Multilingual Language Model (BLOOM), Large Language Model Meta AI (LLaMA), and the like.

Each category-specific model may be trained using documents and other sources of information associated with the corresponding business function. For example, the training data for a category-specific model associated with a legal business function may include texts of relevant laws and regulations, texts of current procedures in the legal business function, relevant case law, relevant legal treatises and legal handbooks, relevant internal documents for the business function, terms and definitions of such terms used within the business function, information from litigation associated with the organization, such as deposition transcripts, court transcripts, legal decisions, legal work product, strategy notes, and the like.

Each category-specific model of category-specific models 110 may be trained to receive a procedure, such as procedure 102, and an indication of a classification of the procedure, such as the classification produced by classifier module 106, and to output a written assessment of whether the procedure is satisfactory for implementation by the organization from the point of view of the corresponding business function. As such, after classifier module 106 classifies a procedure to produce a classification of the procedure, each category-specific model of category-specific models 110 may receive the procedure and an indication of a classification of the procedure output by classifier module 106 and may output a written assessment of whether the procedure is satisfactory from the point of view of the corresponding business function.

Each category-specific model of category-specific models 110 is trained to output, as the corresponding validation report, a written assessment of whether a procedure is satisfactory from the point of view of the corresponding business function in the form of a corresponding validation report. For example, category-specific model 110A may output validation report 112A and category-specific model 110B may output validation report 112B.

A validation report outputted by a category-specific model, such as validation report 112A or validation report 112B, may be a natural language text summary, which may be one or more sentences of text that is a reasoned assessment, taking into account the tier classification of procedure 102, indicating whether procedure 102 is satisfactory, such as whether procedure 102 is approved for implementation by the organization. One example of a validation report may be “I reviewed this procedure and I find it to be satisfactory to do the job needed.” Another example of a validation report may be “I reviewed this procedure and I found it unsatisfactory because this procedure doesn't have the checks and balances need to safely execute the procedure.” Another example of a validation report may be “I reviewed this procedure. Given this procedure is classified as tier one and given that there is a high amount of legal risk, I find the procedure to be unsatisfactory.”

In some examples, each category-specific model may be trained to ask one or more questions about the received procedure, such as “how would you assess the risks of implementing this procedure” and “do you find the procedure to be satisfactory given the risks of implementing this procedure and the classification of this procedure.” The category-specific model may be trained to output a written assessment that answers the one or more questions asked about the received procedure.

In some examples, each category-specific model may be trained to receive user-produced assessments of a procedure and to generate a written assessment based on the user-produced assessments of the procedure. A user-produced assessment of a procedure may be text written by a human about their assessment of the procedure after they have reviewed the procedure. A category-specific model may receive user-produced assessments written by people in the corresponding business function. For example, a category-specific model associated with the legal business function may receive user-produced assessments by lawyers in the legal department of the organization. Similarly, a category-specific model associated with the information technology business function may receive user-produced assessments by information technology workers in the information technology department of the organization. An example of a written assessment based on user-produced assessments of a procedure may be “Three experts have reviewed this procedure. Even though this procedure is classified as tier one and therefore is a risky procedure, every expert had a positive assessment of the procedure. Therefore, this procedure is satisfactory.” Another example of a written assessment based on user-produced assessments of a procedure may be “Two out of the three experts that reviewed this procedure believe this procedure is inadequate. Given that this procedure is classified as tier one and therefore is a risky procedure, this procedure has to be reworked.” Such user-produced assessments of a procedure may also be used, in some examples, as training data for training category-specific models 110 to generate written assessments of procedures.

Combiner module 114 may be trained to receive validation reports 112 from the category-specific models 110 and to output, based on validation reports 112, combined validation report 116. In some examples, in addition to validation reports 112, combiner module 114 may also be operable to receive classification information associated with procedure 102 produced by classifier module 106 and may be trained to output, based on validation reports 112 and the classification information associated with procedure 102, combined validation report 116.

In some examples, combiner module 114 may be a LLM. For example, combiner module 114 may be a foundational model that is further trained with data specific to the organization to receive validation reports 112 from the category-specific models 110 and to output, based on validation reports 112, combined validation report 116.

In some examples, combiner module 114 may be trained to generate combined validation report 116 as a natural language text summary, which may be one or more sentences of text indicating whether procedure 102 is satisfactory, such as whether procedure 102 is approved for implementation by the organization. The summary may be a reasoned assessment of whether procedure 102 is satisfactory that takes into account the tier classification of procedure 102 and validation reports 112 from category-specific models 110.

For example, combiner module 114 may output combined validation report 116 that states “This procedure is high risk. However, the procedure is satisfactory across all of the category-specific models, and therefore the procedure is approved.” In another example, combiner module 114 may output combined validation report 116 that states “This procedure is high risk. The category-specific models produce mixed results for this procedure. Thus the procedure is not approved.” In another example, combiner module 114 may output combined validation report 116 that states “This procedure is low risk. However, the category-specific models produce mixed results for this procedure. This procedure requires further human review for approval.”

In some examples, combiner module 114 may be trained to weigh the outputs of category-specific models 110 as part of determining whether procedure 102 is satisfactory. Such weighing of the outputs of category-specific models 110 may be based on the tier classification of procedure 102, such that combiner module 114 may use a first set of weights to weigh the outputs of category-specific models 110 if procedure 102 is classified as tier 1 and may use a second different set of weights to weigh the outputs of category-specific models 110 if procedure 102 is classified as tier 2. For example, for a procedure classified as being high risk, combiner module 114 may weigh the outputs of category-specific models 110 so that combiner module 114 may find the procedure to be satisfactory if and only if the category-specific legal LLM outputs a report indicating the procedure to be legally satisfactory. In other examples, weighing of the outputs of category-specific modules 110 may be based on factors such as the geographic location in which the procedure is being performed, such as to take into account local rules and regulations, keywords flagged within the procedure, and the like.

In some examples, combiner module 114 may be trained to generate a score for each validation report of validation reports 112 received from category-specific models 110 and to determine whether a procedure is satisfactory or not satisfactory based on whether the total score of validation reports 112 exceeds a threshold score. For example, combiner module 114 may be trained to generate, for each validation report, a score between 1 and 10, where a higher score may indicate that the validation report has a more favorable assessment of the procedure compared to a lower score. Combiner module 114 may be trained to determine a threshold score based on the classification of a procedure, such that combiner module 114 may determine a higher threshold score for a procedure classified into a relatively higher tier (e.g., tier 1) and may determine a lower threshold for a procedure classified into a relatively lower tier.

In some examples, combiner module 114 may be trained to generate combined validation report 116 in the form of a scorecard. The scorecard may include, for each of category-specific models 110, an indication of whether the corresponding validation report produced by the category-specific model indicates a positive assessment of the procedure or a negative assessment of the procedure. For example, combiner module 114 may output combined validation report 116 that indicates, for each category-specific model, whether the category-specific model produced a validation report having a positive assessment or a negative assessment of the procedure. Such a scorecard may, in some examples, include the score determined by combiner module 114 for each of validation reports 112.

Controller module 108 may be operable to select the specific category-specific models 110 that execute to assess a given procedure 102 to produce a corresponding validation report 112. That is, controller module 108 may select all of category-specific models 110 or a subset (i.e., fewer than all) of category-specific models 110 to assess a given procedure to produce a corresponding validation report. Controller module 108 may select, based on the classification of a procedure, the specific category-specific models 110 that execute to assess a given procedure to produce a corresponding validation report. For example, while some category-specific models may be applied to all procedures regardless of their classification, other category-specific models may only be applied to procedures at or above a certain classified tier.

In the example of FIG. 1, computing system 100 may receive or otherwise retrieve (e.g., from a data store) procedure 102 that computing system 100 may process to generate an assessment of whether to approve or deny implementation of procedure 102 within an organization. Classifier module 106 may read or otherwise receive procedure 102 and may generate a classification of procedure 102, such as to classify procedure 102 into a particular tier.

Each of category-specific models 110 may receive procedure 102 and an indication of the classification of procedure 102 and may produce a corresponding validation report of validation reports 112. In some examples, controller module 108 may receive an indication of the classification of procedure 102 outputted by classifier module 106 and may select, based on the classification of procedure 102, a subset of category-specific models 110 for assessing procedure 102. In these examples, the selected category-specific models 110 may receive procedure 102 and the indication of the classification of procedure 102 and may produce a corresponding validation report of validation reports 112.

In examples where category-specific models 110 receive user-produced assessments of procedure 102, controller module 108 may receive the user-produced assessments of procedure 102 from one or more users and may forward the user-produced assessments to category-specific models 110. For example, controller module 108 may receive assessments of procedure 102 from members of the legal team and may forward the received assessments to the category-specific legal model. In another example, controller module 108 may receive assessments of procedure 102 from members of the human resources team and may forward the received assessments to the category-specific human resources model. Each category-specific model may therefore receive one or more user-produced assessments of procedure 102 and may produce a corresponding validation report based on the user-produced assessments.

Combiner module 114 may receive validation reports 112 produced by category-specific models 110 and may, in response, generate combined validation report 116 that is a written assessment of whether to approve or deny implementation of procedure 102 within an organization based on validation reports 112. In some examples, combiner module 114 may generate combined validation report 116 that is a scorecard of each of validation reports 112.

In some examples, combiner module 114 may generate combined validation report 116 based on weighting the validation report produced by each of category-specific models 110. For example, combiner module 114 may determine, based on the classification of procedure 102, a set of weights for weighing the validation report produced by each of category-specific models 110 and may use the weights to weigh the validation report produced by each of category-specific models 110.

In some examples, combiner module 114 may generate combined validation report 116 based on an order of operations for assessing validation reports 112 produced by category-specific models 110. For example, controller module 108 may determine, based on the classification of procedure 102, an order for assessing validation reports 112 produced by category-specific models 110, and may forward the order for assessing validation reports 112 to combiner module 114 for use in generating combined validation report 116.

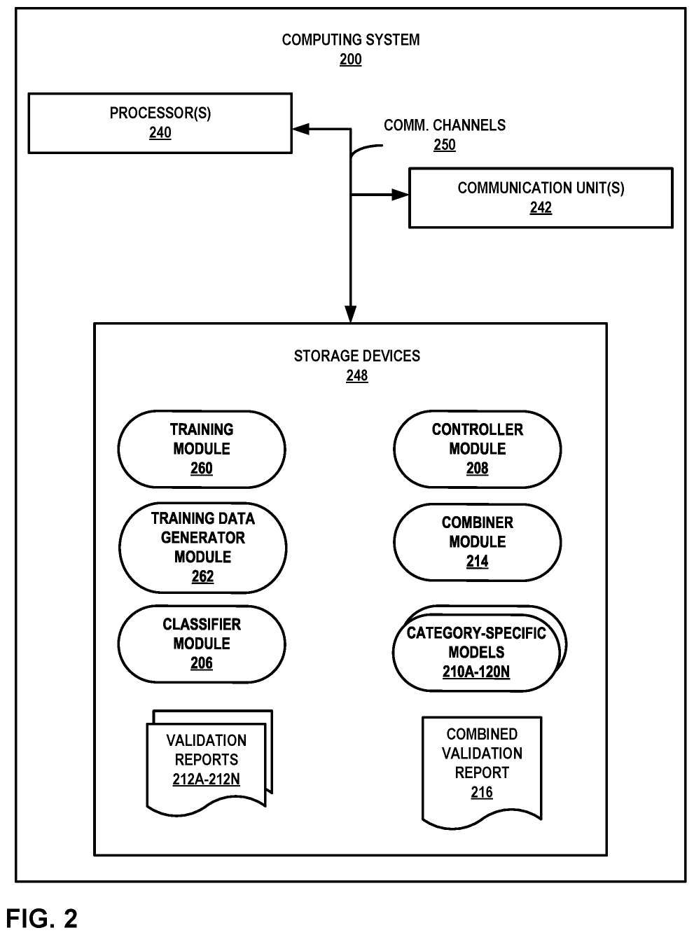

FIG. 2 is a block diagram illustrating an example computing system, in accordance with one or more aspects of the present disclosure. Computing system 200 of FIG. 2 is described below as an example of computing system 100 of FIG. 1. FIG. 2 illustrates only one particular example of computing system 200, and many other examples of computing system 200 may be used in other instances and may include a subset of the components included in example computing system 200 or may include additional components not shown in FIG. 2. For example, computing system 200 may comprise a cluster of servers, and each of the servers comprising the cluster of servers making up computing system 200 may include all, or some, of the components described herein in FIG. 2, to perform the techniques disclosed herein.

For ease of illustration, computing system 200 is depicted in FIG. 2 as a single computing system. However, in other examples, computing system 200 may be implemented through multiple devices or computing systems distributed across a data center or multiple data centers. For example, computing system 200 (or various modules illustrated in FIG. 2 as included within computing system 200) may be implemented through distributed virtualized compute instances (e.g., virtual machines, containers) of a data center, cloud computing system, server farm, and/or server cluster.

As shown in the example of FIG. 2, computing system 200 includes one or more processors 240, one or more communication units 242, and one or more storage devices 248. One or more storage devices 248 include training module 260, training data generator module 262, classifier module 206, controller module 208, category-specific models 210A-210N (“category-specific models 210”), validation reports 212A-212N (“validation reports 212”), combiner module 214, and combined validation report 216. Classifier module 206 is an example of classifier module 106 of FIG. 1. Controller module 208 is an example of controller module 108 of FIG. 1. Category-specific models 210 are examples of category-specific models 110 of FIG. 1. Validation reports 212 are examples of validation reports 112 of FIG. 1. Combiner module 214 is an example of combiner module 114 of FIG. 1. Combined validation report 216 is an example of combined validation report 116 of FIG. 1.

One or more processors 240 may implement functionality and/or execute instructions associated with computing system 200. Examples of one or more processors 240 include application processors, display controllers, auxiliary processors, one or more sensor hubs, and any other hardware configure to function as a processor, a processing unit, or a processing device. Training module 260, training data generator module 262, classifier module 206, controller module 208, category-specific models 210, and combiner module 214 may be operable by one or more processors 240 to perform various actions, operations, or functions of computing system 200. For example, one or more processors 240 of computing system 200 may retrieve and execute instructions stored by one or more storage devices 248 that cause one or more processors 240 to perform the operations of training module 260, training data generator module 262, classifier module 206, controller module 208, category-specific models 210, and combiner module 214. The instructions, when executed by one or more processors 240, may cause computing system 200 to store information within one or more storage devices 248.

One or more communication units 242 of computing system 200 may communicate with external devices via one or more wired and/or wireless networks by transmitting and/or receiving network signals on the one or more networks. Examples of one or more communication units 242 include a network interface card (e.g., such as an Ethernet card), an optical transceiver, a radio frequency transceiver, a global positioning satellite (GPS) receiver, or any other type of device that can send and/or receive information. Other examples of one or more communication units 242 may include short wave radios, cellular data radios, wireless network radios, as well as universal serial bus (USB) controllers.

Communication channels 250 may interconnect each of the components 240, 242, and 248 for inter-component communications (physically, communicatively, and/or operatively). In some examples, communication channels 250 may include a system bus, a network connection, an inter-process communication data structure, or any other method for communicating data.

One or more storage devices 248 within computing system 200 may store information for processing during operation of computing system 200 (e.g., computing system 200 may store data accessed by training module 260, training data generator module 262, classifier module 206, controller module 208, category-specific models 210, and combiner module 214 during execution at computing system 200). In some examples, one or more storage devices 248 is a temporary memory, meaning that a primary purpose of one or more storage devices 248 is not long-term storage. In this example, one or more storage devices 248 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

In some examples, one or more storage devices 248 may also include one or more computer-readable storage media. One or more storage devices 248, in some examples, include one or more non-transitory computer-readable storage mediums. One or more storage devices 248 may be configured to store larger amounts of information than typically stored by volatile memory. One or more storage devices 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. One or more storage devices 248 may store program instructions and/or information (e.g., data) associated with training module 260, training data generator module 262, classifier module 206, controller module 208, category-specific models 210, and combiner module 214. One or more storage devices 248 may include a memory configured to store data or other information associated with training module 260, training data generator module 262, classifier module 206, controller module 208, category-specific models 210, and combiner module 214.

One or more processors 240 are configured to execute training module 260 to train classifier module 206 to classify procedures into tiers. For example, training module 260 may train classifier module 206 using training data that includes a large number (e.g., tens of thousands) of examples procedures and corresponding tier classifications of those procedures to enable classifier module 206 to learn how to classify procedures into tiers.

In some examples, training module 260 may train classifier module 206 to classify procedures into tiers based on keywords contained in the procedures. For examples, training module 260 may train classifier module 206 to count the number of specific keywords in a procedure and to classify the procedure based on the count of the number of specific keywords in the procedure. To train classifier module 206 to classify procedures into tiers based on keywords contained in the procedures, training module 260 may train classifier module 206 using training data that includes a large number (e.g., tens of thousands) of examples of procedures, corresponding counts of keywords, and corresponding tier classifications to enable classifier module 206 to learn associations between counts of keywords and how to classify procedures into tiers.

As described with respect to FIG. 1, each of category-specific models 210 may be a foundational model that is further trained with data specific to the organization and/or to the corresponding business function of the organization. One or more processors 240 are configured to execute training module 260 to train each of category-specific models 210 with data specific to the organization and/or to the corresponding business function of the organization.

One or more processors 240 are also configured to execute training module 260 to fine-tune each of category-specific models 210 to perform the task of providing category-specific assessment and validation of procedures. For example, training module 260 may fine-tune each category-specific model to receive a written procedure and to, in response, output a validation report assessing and validating the written procedure from the point of view of the corresponding business function.

Training module 260 may fine-tune each category-specific model using any suitable technique. For example, training module 260 may fine-tune a category-specific model using control descriptions, which are specific types of prompt or input used to help the model learn and follow certain rules, constraints, or behaviors. Control descriptions may guide the behavior of a model by providing explicit instructions and/or constrains to enable the model to generate text that aligns with specific criteria.

Training module 260 may also fine-tune a category-specific model to provide category-specific assessment and validation of procedures using training data that include a large number (e.g., tens of thousands) of example stimulus and response pairs. Each example stimulus and response pair may include an example procedure and one or more example questions regarding the procedure, and a preferred response to the question. In this way, training module 260 may be able to train and fine-tune a category-specific model to, given a stimulus of a procedure and one or more questions, output a response that answers the question in the form of a validation report.

In some examples, one or more processors 240 are configured to execute training data generator module 262 to generate training data that training module 260 may use to fine-tune category-specific models 210. Training data generator module 262 may include a LLM or other machine trained model that is trained to generate questions about a policy or procedure and corresponding answers to the questions. For example, training data generator module 262 may receive an example procedure for repossessing automotive vehicles and may generate a question such as “can we repossess cars from a deployed service member?” as well as a corresponding answer of “no, we cannot repossess cars from a deployed service member.” Training module 260 may therefore use the example procedure, the question generated by training data generator module 262, and the corresponding answer generated by training data generator module 262 as training data used to fine-tune category-specific models 210.

One or more processors 240 are also configured to execute training module 260 to train and fine-tune category-specific models 210 to crosscheck procedures with other related procedures and policies within the organization and to output validation reports 212 that indicate related procedures and policies within the organization. For example, training module 260 may train category-specific models 210 to use text analysis to find related procedures within the organization, such as procedures that are textually similar to the procedure being assessed and/or other applicable procedures and policies that affect the assessment of the procedure.

In some examples, training module 260 may train and/or fine-tune a category-specific model to generate category-specific assessment and validation of procedures based on user-produced assessments of procedures. For example, training module 260 may train and/or fine-tune a category-specific model using training data that includes pairs of user-produced assessments of a procedure and a corresponding validation report that is based on the user-produced assessments of the procedure.

One or more processors 240 are also configured to execute training module 260 to train and fine-tune combiner module 214 to produce a combined validation report based on category-specific validation reports from each of category-specific models 210. In some examples, combiner module 214 may be a foundational model, and training module 260 may further train combiner module 214 with data and documents specific to the organization to enable combiner module 214 to learn terms and other words that are specific to the organization.

Training module 260 may also fine-tune combiner module 214 to produce a combined validation report based on category-specific validation reports from each of category-specific models 210 using training data that include a large number (e.g., tens of thousands) of example stimulus and response pairs. Each example stimulus and response pair may include a set of example category-specific validation reports generated by category-specific models associated with different business functions and an example combined validation report that synthesizes the category-specific validation reports, thereby enabling combiner module 214 to learn how to generate a combined validation report from category-specific validation reports.

In some examples, the training data may include, in each stimulus and response pair, example weights that correspond to the set of example category-specific validation reports along with the set of example category-specific validation reports generated by category-specific models associated with different business functions and an example combined validation report that synthesizes the category-specific validation reports. Such example weights may enable combiner module 214 to learn how to generate a combined validation report from category-specific validation reports based on weighing the category-specific validation reports based on a set of weights that correspond to the category-specific validation reports.

In some examples, the training data may include, in each stimulus and response pair, an example order of operations for considering the set of example category-specific validation reports along with the set of example category-specific validation reports generated by category-specific models associated with different business functions and an example combined validation report that synthesizes the category-specific validation reports. Such example order of operations may enable combiner module 214 to learn how to generate a combined validation report from category-specific validation reports based on considering the category-specific validation reports according to an order of operations for considering the category-specific validation reports.

In some examples, training module 260 may train combiner module 214 to generate a score for each validation report received by combiner module 214. For example, training module 260 may use training data that includes sets of example validation reports and corresponding scores to train combiner module 214 to be able to determine scores for validation reports.

One or more processors 240 are configured to execute classifier module 206 to classify a procedure into one or more tiers of a plurality of tiers. Classifier module 206 may classify a procedure based on factors such as whether the procedure affects external customers of the organization, the number of external customers that are affected by the procedure, reputational risk to the organization, and the like. For example, classifier module 206 may classify a procedure as being in the highest tier (e.g., tier 1) if classifier module 206 determines that the procedure affects external customers of the organization and may classify a procedure as being in a relatively lower tier (e.g., tier 2 or lower) if classifier module 206 determines that the procedure does not affect external customers of the organization.

One or more processors 240 are configured to execute category-specific models 210 to assess and validate a procedure. That is, category-specific models 210 may receive a procedure and an indication of the classification the procedure, such as determined by classifier module 206, to generate corresponding validation reports 212A-212N (“validation reports 212”) that are written assessments of whether the procedure is satisfactory for the organization. Validation reports 212 are examples of validation reports 112 of FIG. 1.

Each category-specific model of category-specific models 210 may be associated with a corresponding business function of an organization. Examples of business functions of an organization may include legal, regulatory, human resources, process management, operational, information technology, marketing and sales, public relations, finance, and/or other business functions. As such, each category-specific model of category-specific models 210 may receive the procedure and an indication of a classification of the procedure outputted by classifier module 206 and may output a corresponding validation report that is a written assessment of whether the procedure is satisfactory from the point of view of the corresponding business function, taking into account the classification of the procedure.

In some examples, one or more processors 240 are configured to execute controller module 208 to receive an indication of the classification the procedure, such as determined by classifier module 206. One or more processors 240 may therefore be configured to execute controller module 208 to select, based on the classification of the procedure, the specific category-specific models 210 that execute to assesses a given procedure to produce a corresponding validation report. That is, controller module 208 may, based on the classification of the procedure, select all of category-specific models 210 or a subset (i.e., fewer than all) of category-specific models 210 to execute to assess a given procedure to produce a corresponding validation report.

For example, if a procedure is classified in the highest tier (e.g., tier 1), controller module 208 may select each model of category-specific models 210 to execute to assess a given procedure to produce a corresponding validation report. In another example, if a procedure is classified as being in a next lower tier (e.g., tier 2), controller module 208 may refrain from selecting a category-specific model associated with the legal business function associated with the organization to execute to assess a given procedure and to produce a corresponding validation report. One or more processors 240 may therefore be configured to execute the subset of category-specific models 210 selected by controller module 208 to each receive the procedure and an indication of the classification of the procedure and to each output a corresponding validation report.

In some examples, each of category-specific models 210 may receive user-produced assessments of a procedure and to generate a corresponding validation report based on the user-produced assessments. A user-produced assessment of a procedure may be text written by a human about their assessment of the procedure after they have reviewed the procedure. A category-specific model may receive user-produced assessments written by people in the corresponding business function. For example, a category-specific model associated with the legal business function may receive user-produced assessments by lawyers in the legal department of the organization. Similarly, a category-specific model associated with the information technology business function may receive user-produced assessments by information technology workers in the information technology department of the organization.

One or more processors 240 may be configured to execute controller module 208 to receive user-produced assessments of a procedure and to forward the received user-produced assessments of the procedure to category-specific models 110. Controller module 208 may receive, via one or more communication units 244, user-produced assessments from computing devices associated with users that produced the user-produced assessments, and may forward the received user-produced assessments of the procedure to category-specific models 110. Controller module 208 may forward user-produced assessments received from a business function of an organization to the category-specific model that corresponds to the business function. For example, controller module 208 may forward user-produced assessments received from the legal department to the specific category-specific model that corresponds to the legal business function for the organization.

One or more processors 240 are configured to execute combiner module 214 to receive validation reports 212 from category-specific models 210 and to generate, based on validation reports 212, combined validation report 216. Combined validation report 216 may be a written assessment of whether to approve or deny implementation of a procedure within an organization based on validation reports 212. In some examples, in addition to validation reports 212, combiner module 214 may also be operable to receive an indication of the classification of the procedure produced by classifier module 206 and may, based on validation reports 212 and the classification of the procedure, output combined validation report 216.

In some examples, combined validation report 216 may be a natural language text summary, which may be one or more sentences of text indicating whether a procedure is satisfactory, such as whether the procedure is approved for implementation by the organization. The summary may be a reasoned assessment of whether the procedure is satisfactory that accounts for the tier classification of the procedure and validation reports 212 from category-specific models 210.

In some examples, combiner module 214 may generate combined validation report 216 based on weighing the validation report produced by each of category-specific models 210. Such weighing of validation reports 212 may be based on the tier classification of a procedure. For example, combiner module 214 may use a first set of weights to weigh the outputs of category-specific models 210 if a procedure is classified as tier 1 and may use a second different set of weights to weigh the outputs of category-specific models 210 if the procedure is classified as tier 2. For example, for a procedure classified as being high risk, combiner module 214 may weigh the outputs of category-specific models 210 so that combiner module 214 may find the procedure to be satisfactory if and only if the category-specific legal model outputs a report indicating the procedure to be legally satisfactory.

In some examples, combiner module 214 may generate combined validation report 216 based on a specific order of operations to analyze the validation report produced by each of category-specific models 210. Such an order of operations may be based on the tier classification of a procedure. For example, if a procedure is classified as tier 1, combiner module 214 may use a first order for assessing validation reports 212 produced by category-specific models 210. Similarly, if a procedure is classified as tier 2, combiner module 214 may use a second order for assessing validation reports 212 produced by category-specific models 210.

For example, if a procedure is classified as being high risk, combiner module 214 may use an order of operations that first assesses the validation report outputted by a category-specific legal model to determine whether the category-specific legal model assesses that the procedure to be legally satisfactory. If combiner module 214 determines that the category-specific legal model assessed that the procedure to be unsatisfactory, combiner module 214 may generate combined validation report 216 that indicates the procedure as being unsatisfactory without assessing the validation reports from the other category-specific models.

If combiner module 214 determines that the category-specific legal model assessed that the procedure to be satisfactory, combiner module 214 may use the order of operations to subsequently determine whether the category-specific regulatory model assesses that the procedure to satisfy regulations associated with the procedure. If combiner module 214 determines that the category-specific regulatory model assessed that the procedure to be satisfactory, combiner module 214 may subsequently determine, based on the assessments of the other category-specific legal models of the procedure, whether the procedure is satisfactory.

Combiner module 214 may determine a set of weights for weighing the validation report produced by each of category-specific models 210 based on the classification of the procedure, the geographic location in which the procedure is to be performed, flagged keywords in the procedure, and the like. Combiner module 214 may use the determined set of weights to weigh the validation report produced by each of category-specific models 210. In some examples, the set of weights may include, for each category-specific model, a weight that ranges from 0.0 to 1.0. A weight of 0.0 associated with a category-specific model may indicate that combiner module 214 is to ignore the validation report produced by the category-specific model. Similarly, a weight of 1.0 associated with a category-specific model may indicate that combiner module 214 is to generate a positive written assessment of the procedure only if the validation report produced by the category-specific model associated with a weight of 1.0 is a positive assessment of the procedure, which may in effect give the category-specific model veto power over the assessment of the procedure.

In some examples, combiner module 214 may generate a score for each validation report of validation reports 212 received from category-specific models 210 and to determine whether a procedure is satisfactory or not satisfactory based on whether the total score of validation reports 212 exceeds a threshold score. For example, combiner module 214 may generate, for each validation report, a score between 1 and 10, where a higher score may indicate that the validation report has a more favorable assessment of the procedure compared to a lower score.

Combiner module 214 may also determine a threshold score for the procedure. For example, combiner module 214 may determine the threshold score based on the classification of the procedure, such that combiner module 214 may determine a higher threshold score for a procedure classified into a relatively higher tier (e.g., tier 1) and may determine a lower threshold for a procedure classified into a relatively lower tier. Combiner module 214 may therefore compare the total score of validation reports 212 against the threshold score to determine whether to output combined validation report 216 having a positive assessment of the procedure or a negative assessment of the procedure.

In some examples, combiner module 214 may output combined validation report 216 in the form of a scorecard. The scorecard may include, for each of category-specific models 210, an indication, such as a score, of whether the corresponding validation report produced by the category-specific model is satisfactory for the corresponding business function. For example, combiner module 214 may output combined validation report 216 that indicates, for each category-specific model, whether the category-specific model produced a validation report having a positive assessment or a negative assessment of the procedure.

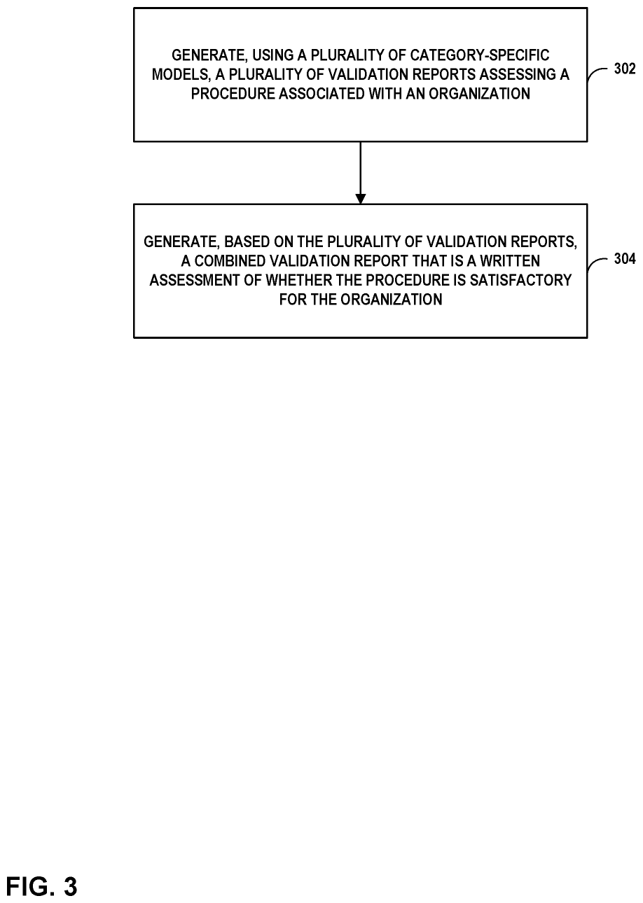

FIG. 3 is a flow diagram illustrating operations performed by an example computing system, in accordance with one or more aspects of the present disclosure. FIG. 3 is described below within the context of computing system 200 of FIG. 2. In other examples, operations described in FIG. 3 may be performed by one or more other components, modules, systems, or devices. Further, in other examples, operations described in connection with FIG. 3 may be merged, performed in a difference sequence, omitted, or may encompass additional operations not specifically illustrated or described.

In the process illustrated in FIG. 3, and in accordance with one or more aspects of the present disclosure, one or more processors 240 may generate, using a plurality of category-specific models 210, a plurality of validation reports 212 assessing a procedure, e.g., procedure 102 of FIG. 1, associated with an organization, wherein each category-specific model of the plurality of category-specific models 210 is associated with a corresponding business function of the organization and is trained via machine learning to produce a corresponding validation report that is a written assessment of whether the procedure 102 is satisfactory for the corresponding business function (302).

In some examples, to generate the plurality of category-specific validation reports 212, the one or more processors 240 may determine a classification of the procedure 102 and may generate, using the plurality of category-specific models 210, the plurality of validation reports 212 assessing the procedure 102 based on the classification of the procedure 102. In some examples, one or more processors 240 may select, based on the classification of the procedure 102, a subset of a second plurality of category-specific models as the plurality of category-specific models 210.

One or more processors 240 may generate, based on the plurality of validation reports 212, a combined validation report 216 that is a written assessment of whether the procedure 102 is satisfactory for the organization (304). In some examples, to generate the combined validation report 216, the one or more processors 240 may determine, based on the classification of the procedure 102, a set of weights for weighing the plurality of validation reports 212 and may weight the plurality of validation reports 212 using the set of weights to generate the combined validation report 216. In some examples, to generate the combined validation report 216, the one or more processors 240 may determine, based on the classification of the procedure 102, an order of operations for assessing the plurality of validation reports 212 and may assess the plurality of validation reports 212 according to the order of operations to generate the combined validation report 216.

In some examples, each category-specific model of the plurality of category-specific models 210 is a large language model (LLM) trained using machine learning to produce the corresponding validation report that is the written assessment of whether the procedure 102 is satisfactory for the corresponding business function. In some examples, each category-specific model of the plurality of category-specific models 210 is trained using corresponding training data that includes sets of an example procedure, an example classification of the example procedure, and an example validation report for the example procedure to learn to generate validation reports for procedures.

In some examples, each category-specific model of the plurality of category-specific models 210 is trained using corresponding training data that includes the documents associated with the corresponding business function. In some examples, each category-specific model of the plurality of category-specific models 210 is trained to ask one or more questions about the procedure 102 and to generate an answer to the one or more questions as the corresponding validation report.

In some examples, the written assessment of whether the procedure 102 is satisfactory for the corresponding business function is a natural language text summary that indicates whether the procedure 102 is satisfactory for implementation by the organization.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any such disclosure material that is incorporated by reference conflicts with the present disclosure, the present disclosure shall control.

For ease of illustration, only a limited number of devices (e.g., computing system 100, computing system 200, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
generating, by one or more processors and using a plurality of category-specific models, a plurality of validation reports assessing a procedure associated with an organization, wherein each category-specific model of the plurality of category-specific models is associated with a corresponding business function of the organization and is trained via machine learning to produce a corresponding validation report that is a written assessment of whether the procedure is satisfactory for the corresponding business function; and
generating, by the one or more processors and based on the plurality of validation reports, a combined validation report that is a written assessment of whether the procedure is satisfactory for the organization.

2. The method of claim 1, wherein generating the plurality of validation reports further comprises:
determining, by the one or more processors, a classification of the procedure; and
generating, by the one or more processors and using the plurality of category-specific models, the plurality of validation reports assessing the procedure based on the classification of the procedure.

3. The method of claim 2, further comprising:
selecting, by the one or more processors and based on the classification of the procedure, a subset of a second plurality of category-specific models as the plurality of category-specific models.

4. The method of claim 2, wherein generating the combined validation report further comprises:
determining, by the one or more processors and based on the classification of the procedure, a set of weights for weighing the plurality of validation reports; and
weighing, by the one or more processors, the plurality of validation reports using the set of weights to generate the combined validation report.

5. The method of claim 2, wherein generating the combined validation report further comprises:
determining, by the one or more processors and based on the classification of the procedure, an order of operations for assessing the plurality of validation reports; and
assessing, by the one or more processors, the plurality of validation reports according to the order of operations to generate the combined validation report.

6. The method of claim 1, wherein generating the combined validation report further comprises:
determining, by one or more processors, a corresponding score for each category-specific model of the plurality of category-specific models; and
generating, by the one or more processors, the combined validation report as a scorecard based on the corresponding score for each category-specific model of the plurality of category-specific models.

7. The method of claim 1, wherein a combiner model is a large language model (LLM), further comprising:
training, by the one or more processors and using machine learning, the combiner model to generate, based on the plurality of validation reports, the combined validation report that is the written assessment of whether the procedure is satisfactory for the organization.

8. The method of claim 1, wherein each category-specific model of the plurality of category-specific models is a large language model (LLM), further comprising:
training, by the one or more processors and using machine learning, each category-specific model of the plurality of category-specific models to produce the corresponding validation report that is the written assessment of whether the procedure is satisfactory for the corresponding business function.

9. The method of claim 8, wherein each category-specific model of the plurality of category-specific models is trained using corresponding training data that includes sets of an example procedure, an example classification of the example procedure, and an example validation report for the example procedure to learn to generate validation reports for procedures.

10. The method of claim 8, wherein each category-specific model of the plurality of category-specific models is trained using corresponding training data that includes documents associated with the corresponding business function.

11. The method of claim 8, wherein each category-specific model of the plurality of category-specific models is trained to ask one or more questions about the procedure and to generate an answer to the one or more questions as the corresponding validation report.

12. The method of claim 1, wherein the written assessment of whether the procedure is satisfactory for the corresponding business function is a natural language text summary that indicates whether the procedure is satisfactory for implementation by the organization.

13. A computing system comprising:
memory configured to store a plurality of category-specific models; and
one or more processors configured to:
generate, using the plurality of category-specific models, a plurality of validation reports assessing a procedure associated with an organization, wherein each category-specific model of the plurality of category-specific models is associated with a corresponding business function of the organization and is trained via machine learning to produce a corresponding validation report that is a written assessment of whether the procedure is satisfactory for the corresponding business function; and
generate, based on the plurality of validation reports, a combined validation report that is a written assessment of whether the procedure is satisfactory for the organization.

14. The computing system of claim 13, wherein to generate the plurality of validation reports, the one or more processors are further configured to:
determine a classification of the procedure; and
generate, using the plurality of category-specific models, the plurality of validation reports assessing the procedure based on the classification of the procedure.

15. The computing system of claim 14, wherein the one or more processors are further configured to:
select, based on the classification of the procedure, a subset of a second plurality of category-specific models as the plurality of category-specific models.

16. The computing system of claim 14, wherein to generate the combined validation report, the one or more processors are further configured to:
determine, based on the classification of the procedure, a set of weights for weighing the plurality of validation reports; and
weigh the plurality of validation reports using the set of weights to generate the combined validation report.

17. The computing system of claim 14, wherein to generate the combined validation report, the one or more processors are further configured to:
determine, based on the classification of the procedure, an order of operations for assessing the plurality of validation reports; and
assess the plurality of validation reports according to the order of operations to generate the combined validation report.

18. The computing system of claim 13, wherein a combiner model is a large language model (LLM), and wherein the one or more processors are further configured to:
Train, using machine learning, the combiner model to generate, based on the plurality of validation reports, the combined validation report that is the written assessment of whether the procedure is satisfactory for the organization.

19. The computing system of claim 13, wherein each category-specific model of the plurality of category-specific models is a large language model (LLM), and wherein the one or more processors are further configured to:
train, using machine learning, each category-specific model of the plurality of category-specific models to produce the corresponding validation report that is the written assessment of whether the procedure is satisfactory for the corresponding business function.

20. A non-transitory computer-readable medium comprising instructions that, when executed, cause one or more processors of a computing system to:
generate, using a plurality of category-specific models, a plurality of validation reports assessing a procedure associated with an organization, wherein each category-specific model of the plurality of category-specific models is associated with a corresponding business function of the organization and is trained via machine learning to produce a corresponding validation report that is a written assessment of whether the procedure is satisfactory for the corresponding business function; and
generate, based on the plurality of validation reports, a combined validation report that is a written assessment of whether the procedure is satisfactory for the organization.
